(19) United States
(12) Patent Application Publication
(10) Pub. No.: US 2014/0129615 A1
(43) Pub. Date: May 8, 2014

(54) SYSTEM FOR AUTOMATED DATA MEASUREMENT AND ANALYSIS

(71) Applicant: TIMEST LTD., Jerusalem (IL)

(72) Inventor: Noam BAND, Rosh Haayin (IL)

(73) Assignee: TIMEST LTD., Jerusalem (IL)

(21) Appl. No.: 13/668,375

(22) Filed: Nov. 5, 2012

(51) Int. Cl. H04L 12/26

(52) U.S. Cl. CPC H04L 43/04
USPC 709/203

(57) ABSTRACT

The detection and interpretation of data pertaining to the usage of software and documents by end users, and more specifically, the automation of the mining of raw hierarchical object data for information on specific software and document usage and the automatic generation of statistical data on its usage and runtime errors.

### FIELD OF THE INVENTION

The present invention relates to the detection and interpretation of data pertaining to the usage of software and documents by end users, and more specifically, the automation of the mining of raw hierarchical object data for information on specific software and document usage and the automatic generation of statistical data on its usage and runtime errors.

### BACKGROUND OF THE INVENTION

At present, projects in the value of 600 Billion US dollars are deployed yearly in the US alone. When organizations decide to roll out a new application, only rarely does this decision rely on objective measures of the pilot users, according to the critical business processes of the organizations. Adopting a new application involves, in almost all cases, a massive change in business processes and a new way of working. In most organizations the meaning of that is that on rollout phase the risk of the organization climbs dramatically, leaving the entire organization exposed to a huge failure of his critical processes on the first days of deployment. It is no secret that on those risky days most business processes are wrongly used and some are never used; and when some are used correctly, the extended user environment is disruptive to the effective utilization. It is almost impossible for organizations to know which processes are ready to rollout and which actions must be taken before rollout. Rollout is a critical phase in the process of enrollment of a new critical application in organizations. Although failure in this stage mean harmful results to the organization (regardless of the funds and time invested in deploying the application) and may lead to total disaster, there are currently no automated tools to deal with this stage.

In light of the above, there remains an unmet long felt need for providing an automated and rapid system and method for monitoring actual usage of a software product for the purposes of quality control or launching readiness and similar purposes.

### SUMMARY OF THE INVENTION

It is an object of the present invention to provide a system for automatically interpreting object usage on a plurality of end users' computers comprising a plurality of computers used by end users (EUCs), a central server (server) with processing means and first information storage means adapted for storing: captured raw object data, an updatable library of object classes, computer readable instructions for identifying class-relevant and title-relevant information in raw object data and comparing to said library of object classes, or object models (OMs) and a log of OM instances, comprising data on class, title, time and duration of usage of said OM instances. In order to capture the object raw data, use is made of a plurality of listener devices (listeners) possessing a second information storage means and first means of communications with one or more EUCs, and adapted for obtaining from said EUCs information on object activity, and a second means of communication with server for passing said object usage information.

It is an object of the present invention to provide a system wherein said object is selected from a group consisting of screen types, Button Control Type, Calendar Control Type, CheckBox Control Type, ComboBox Control Type, DataGrid Control Type, Data Item Control Type, Document Control Type, Edit Control Type, Group Control Type, Header Control Type, HeaderItem Control Type, Hyperlink Control Type, Image Control Type, List Control Type, ListItem Control Type, Menu Control Type, MenuBar Control Type, Menu Item Control Type, Pane Control Type, ProgressBar Control Type, RadioButton Control Type, ScrollBar Control Type, Separator Control Type, Slider Control Type, Spinner Control Type, SplitButton Control Type, StatusBar Control Type, Tab Control Type, TabItem Control Type, Table Control Type, Text Control Type, Thumb Control Type, TitleBar Control Type, ToolBar Control Type, ToolTip Control Type, Tree Control Type, TreeItem Control Type, Window Control Type or any combination thereof.

To fulfill its objective, the said server is equipped with processing means which comprise an identifying means for object class-relevant and title-relevant information in raw object data, instructions for creating OM candidates and comparing to said candidates to updatable library of OMs and determining either the assignation of an existing class to OM instance according to predetermined criteria or conferring permanent class status to OM candidate by adding it to said updatable library of classes, server further recording assigned class, as well as title and object usage information in said object instance log.

A second embodiment of the present invention comprises an OM library which is structured hierarchically, with said object classes grouped into a plurality of class levels, and further wherein the stored computer readable instructions further comprise instructions for creating OM of each raw datum at a plurality of levels, and for identifying and storing OM instances on a plurality of levels.

A further embodiment of the present invention further incorporates a user feedback module comprising a user interface displaying to human user results of automatic OM identification produced by the server and receiving corrections from said user, wherein said corrections are fed back to the server to improve library of previously stored Object Models and possibly also to change stored instructions for class and title identification and matching with OM library.

In a further embodiment of the present invention the server further comprises a database of organizational structure, including departmental affiliation and professional roles of owners of individual EUCs (users) and stored instructions for extracting a plurality of OM usage statistics comprising OM usage time averages per individual user, per department, per role.

In a further embodiment of the present invention the listener module further comprises means for recording error information provided by EUC for errors encountered while attempting to run and errors captured during successful runs of individual OMs, and wherein server also has instructions for extracting OM error statistics.

In a further embodiment of the present invention, the system of interpreting object usage is implemented on a Microsoft Windows platform, and further wherein said listener is adapted to retrieve data on user's object usage from windows system-call, DLL-injection and system events.

In a further embodiment of the present invention, the listener is adapted to retrieve data on user's object usage of objects consisting of web-based documents is retrieved via Browser Helper Object (BHO) module.

In a further embodiment of the present invention, the data on each user's object usage of Java-based programs is identified using inner java-mechanics.

In a further embodiment of the present invention, the data on each user's object usage is based on User-Interface-Automation technique.

In a further embodiment of the present invention, the discovery of OMs is achieved via “class”-dependent heuristics.

In a further embodiment of the present invention, the discovery of OMs is achieved via heuristics based on statistics for overall matching percentages (for example, percentage of data left unmatched, number of models percentage of data each model matches).

In a further embodiment of the present invention, the system further comprises a cloud server enabling EUC to store data and perform computations on cloud server, wherein listener module further comprises a means for capturing data and instructions transmitted between computer and cloud server, useful for identifying objects running on the cloud.

In a further embodiment of the present invention, the first and second identifying means are adapted for using the document object model (DOM) structure of objects consisting of HTML, XHTML or XML documents to identify objectclass and title relevant information. In a further embodiment of the present invention, the DOM model is specified by the World Wide Web Consortium (W3C) DOM standard.

It is an object of the present invention to disclose a method for using a system for automatically interpreting object usage on end user computers, the system comprising a plurality of end user computers (EUCs), a plurality of listening devices (listeners) and a central server (server), and at least one database stored in the memory of the server having a processing means and information storage means adapted for storing captured raw object data, an updatable library of object classes, computer readable instructions for identifying class-relevant and title-relevant information in raw object data and comparing to said library of object classes, or object models (OMs), a log of OM instances, comprising data on class, title, time and duration of usage of said OM instances. The method comprises steps of receiving raw object data from EUCs to be stored in said listeners and server memory; identifying within said raw object, object class and object title relevant information and automatically creating at least one Object Model (OM) candidate class; comparing said at least one OM candidate class to OMs in said updatable OM library and determining whether said at least one candidate class is equivalent to one class in OM library; if said at least one OM candidate class is equivalent to an OM in said library, storing said OM from library and title and temporal usage information as OM instance in OM instance log; if none of said at least one OM candidate class is equivalent to any OM in library, choosing one of OM candidates and adding to said library, thereby creating new OM, storing said OM and title and temporal usage information as OM instance in OM instance log.

It is an object of the present invention to disclose the aforementioned method wherein said object is selected from a group consisting of screen type, Button Control Type, Calendar Control Type, CheckBox Control Type, ComboBox Control Type, DataGrid Control Type, Data Item Control Type, Document Control Type, Edit Control Type, Group Control Type, Header Control Type, HeaderItem Control Type, Hyperlink Control Type, Image Control Type, List Control Type, ListItem Control Type, Menu Control Type, MenuBar Control Type, Menu Item Control Type, Pane Control Type, ProgressBar Control Type, RadioButton Control Type, ScrollBar Control Type, Separator Control Type, Slider Control Type, Spinner Control Type, SplitButton Control Type, StatusBar Control Type, Tab Control Type, TabItem Control Type, Table Control Type, Text Control Type, Thumb Control Type, TitleBar Control Type, ToolBar Control Type, ToolTip Control Type, Tree Control Type, TreeItem Control Type, Window Control Type or any combination thereof.

It is an object of the present invention to disclose a modified method, wherein the method further comprising step of providing the system with a user interface on EUC and instructions in memory of server for obtaining user feedback, and further displaying to human user results of automatic OM identification produced by server and receiving corrections from said user, wherein said corrections are fed back to the server to improve library of previously stored OMs and possibly also to change stored instructions for class and title identification and matching with OM library.

It is an object of the present invention to disclose a modified method, wherein the method further comprising step of providing in information stored on server a database of organizational structure, including departmental affiliation and professional roles of owners of individual EUCs (users), wherein said information is used for extracting a plurality of OM usage statistics comprising OM usage time averages per individual user, per department, per role.

It is an object of the present invention to disclose a modified method, wherein the listener captures and transmits to server information further comprising error information provided by EUC for errors encountered while attempting to run and errors captured during successful runs of individual OMs, and further wherein server also extracts OM error statistics.

It is an object of the present invention to disclose a method, especially adapted for interpreting object usage on a Microsoft Windows platform, wherein said listener is used for retrieving data on the user's object usage from windows system-call, dll-injection and system events.

It is an object of the present invention to disclose a modified method, wherein the method further comprising step of retrieving data on user's usage of objects consisting of web-based documents is retrieved by said listener via a Browser Helper Object (BHO) module.

It is an object of the present invention to disclose a method, wherein data on user's object usage of Java-based programs is identified using inner java-mechanics.

A further embodiment of the present invention is a method, wherein data on user's object usage is identified based on User-Interface-Automation technique.

It is an object of the present invention to disclose a method, wherein discovery of OMs is achieved via “class”-dependent heuristics.

It is an object of the present invention to disclose a method, wherein discovery of OMs is achieved via heuristics based on statistics for overall matching percentages (for example, percentage of data left unmatched, number of models, percentage of data each model matches).

It is an object of the present invention to disclose a modified method, wherein the method further comprising step of providing a cloud server enabling EUC to store data and perform computations on cloud server, wherein listener module further capturing data and instructions transmitted between computer and cloud server, useful for identifying objects running on cloud.

It is an object of the present invention to disclose a modified method, wherein the method further comprising step of identifying class and title information of objects consisting of HTML, XHTML or XML documents of type is achieved using the document object model (DOM) structure.

It is an object of the present invention to disclose a method, wherein DOM model is specified by the World Wide Web Consortium (W3C) DOM standard.

It is an object of the present invention to disclose a method, wherein a listener is provided on each EUC by downloading from global communications network a computer program (installer) adapted for installing said listener on said EUC.

It is an object of the present invention to disclose a method for extracting software usage and error statistics, comprising providing a means for monitoring and automatically identifying object (SO) usage by EUC users, and further monitoring error messages related to said objects; providing a database of organizational structure, including departmental affiliation and professional roles of owners of individual EUCs (users); combining said identified object usage and error data into usage statistics, comprising: the length of time it takes to open client documents and programs; the number of errors during each process; the rates at which various document types and programs are aborted; the attribution of abort to triggering by another process; partial statistics by department and roll.

### BRIEF DESCRIPTION OF THE DRAWINGS

The structure, operation and advantages of the presently preferred embodiment of this invention will become further apparent upon consideration of the following description, taken in conjunction with the accompanying drawings, wherein:

FIGS. 1 and 2 are schematic diagrams illustrating two embodiments of a system for automated data measurement and analysis.

FIG. 3 is a flowchart illustrating a method for using the system according to the present invention.

FIGS. 4 and 5 are schematic diagrams of automatic object discovery and matching, respectively, which may be applied of various types of raw hierarchical data.

FIG. 6a is a schematic diagram illustrating several levels of hierarchical data class and values.

FIG. 6b is a schematic diagram illustrating a possible Object Model (SM) corresponding to an instance of object raw data.

FIG. 7 is a schematic diagram illustrating a second embodiment of a method for using the system according to the present invention.

### DETAILED DESCRIPTION OF THE INVENTION

One straightforward approach to monitoring actual usage of a product by end users would be to store frequent objectshots of the end users' computers, and then go over them manually for interpretation and analysis. In practice, such a procedure would result in prohibitively large amounts of raw data and consequently tedious or even impracticable manual processing.

The present invention provides a means for automatically reducing the heaps of raw data into more manageable higher level information. For example, a objectshot containing several windows each displaying a word processing document is automatically summarized by a list of “objects” of class “MS Word document” together with their individual titles, status (e.g., ‘running’, ‘not responding’, error messages), and temporal information (such as the time the document was opened). Once such higher level information from several users is available, automated analysis of usage statistics is carried out, along with error analysis including whether errors were triggered by another program. It is herein acknowledged that the present invention monitors actual usage of objects including objects of the following types; screen types, Button Control Type, Calendar Control Type, CheckBox Control Type, ComboBox Control Type, DataGrid Control Type, Data Item Control Type, Document Control Type, Edit Control Type, Group Control Type, Header Control Type, HeaderItem Control Type, Hyperlink Control Type, Image Control Type, List Control Type, ListItem Control Type, Menu Control Type, MenuBar Control Type, Menu Item Control Type, Pane Control Type, ProgressBar Control Type, RadioButton Control Type, ScrollBar Control Type, Separator Control Type, Slider Control Type, Spinner Control Type, SplitButton Control Type, StatusBar Control Type, Tab Control Type, TabItem Control Type, Table Control Type, Text Control Type, Thumb Control Type, TitleBar Control Type, ToolBar Control Type, ToolTip Control Type, Tree Control Type, TreeItem Control Type, Window Control Type or any combination thereof.

The collection of data may be from different sources. Some of these sources can be log files from applications or operating systems. Some Microsoft control types are extracted using UI automation.

Microsoft UI Automation is an accessibility framework for Windows. It provides programmatic access to most UI elements on the desktop. It enables assistive technology products, such as screen readers, to provide information about the UI to end users and to manipulate the UI by means other than standard input. UI Automation also allows automated test scripts to interact with the UI.

The goal of measuring and analyzing the data (the Discovery data flow, FIG. 4) is to create models for objects, which will be used later to create “instances” of the models (the Matching Data Flow, FIG. 5), in order to gather information regarding the object (For example: how much time did the user spend on it).

Raw Hierarchical Data

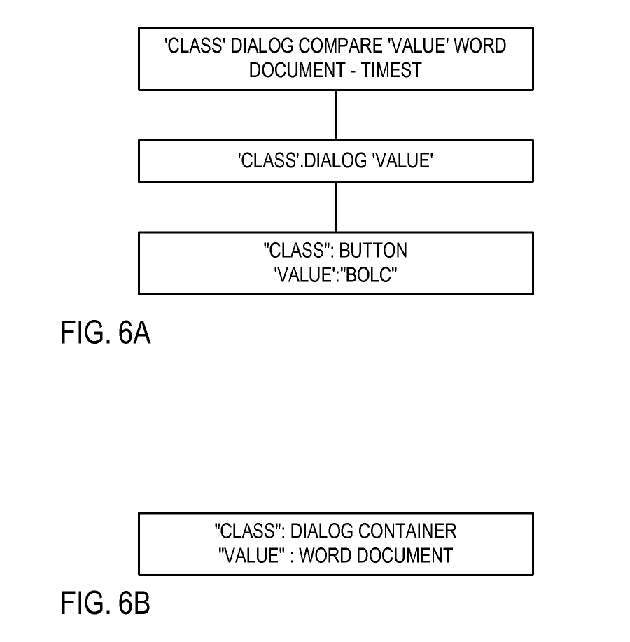

Raw hierarchical data refers to data that can be represented in some hierarchy conforming to a particular data structure. For example (see FIG. 6a), a specific element in a DOM tree is a hierarchical datum, since we can trace its parents' elements up to the DOM tree's root (“body” element). Another data hierarchy can be achieved by any object the user interacts with on the computer's user interface (UI). Each level in data hierarchy has a “class” and “value”, either can be constructed from one or more data types. For example, a button in a DOM document has a class that's composed of tag (“Button”), id (“button1”) and a value with is simply text (“OK”).

Data Capture

A possible embodiment of the present invention can use various different techniques to receive the corresponding types of raw (hierarchical) data.

For Windows-based programs, use is made of windows system-call, dll-injection and system events to retrieve the data. For Web-based programs, a Browser Helper Object (BHO) technique is used. For Java-based programs, inner java-mechanics are employed.

Another embodiment employs a generic data collector, based on User-Interface-Automation application programming interface.

Object Models

The output of the data analysis is collection of object models (SM). OM are similar to the hierarchical data, only that the class/value pairs are represented by regular expressions (and not strings), and each OM has a unique-id. The goal of the OM is to have a generic template, so that when we encounter an hierarchical data, we can try and “match” it to the model, and if there is a match, return the unique-id.

For example, FIG. 6b displays an OM that representing a word document (inferred from the above example and FIG. 6a).

Note that the OM is indifferent to the lower levels (hence, it does not matter whether the lower level is a button or a list), and on the highest level, it is indifferent to the document's title (thus will match for both values “Word Document—Timest” and “Word Document—Chocolate cake recipe”).

Data Analysis

In the preferred embodiment of the present invention, in order to extract object models from the raw hierarchical data, the following are used: “class”-dependent heuristics; Statistics for overall matching percentages (how much data is left unmatched? how many models we have? how much data each model matches? etc.); Statistics for extracting correct regular expressions for “values” at specific level, and in relation with other level.

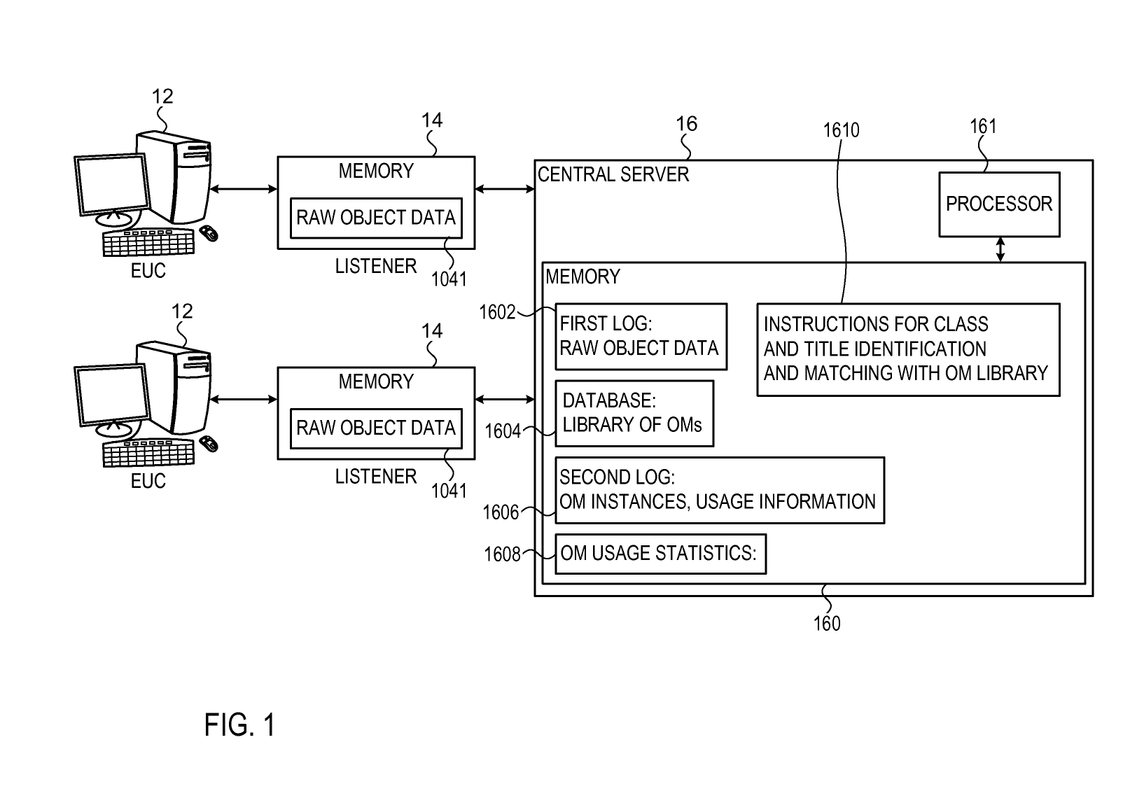

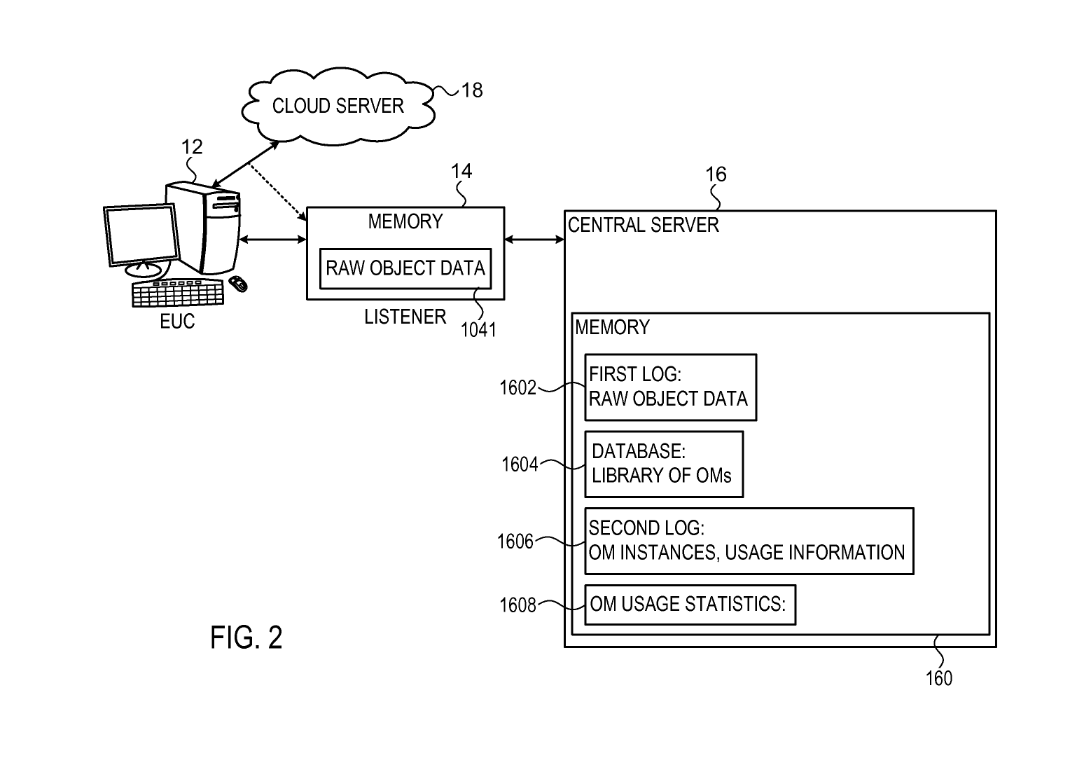

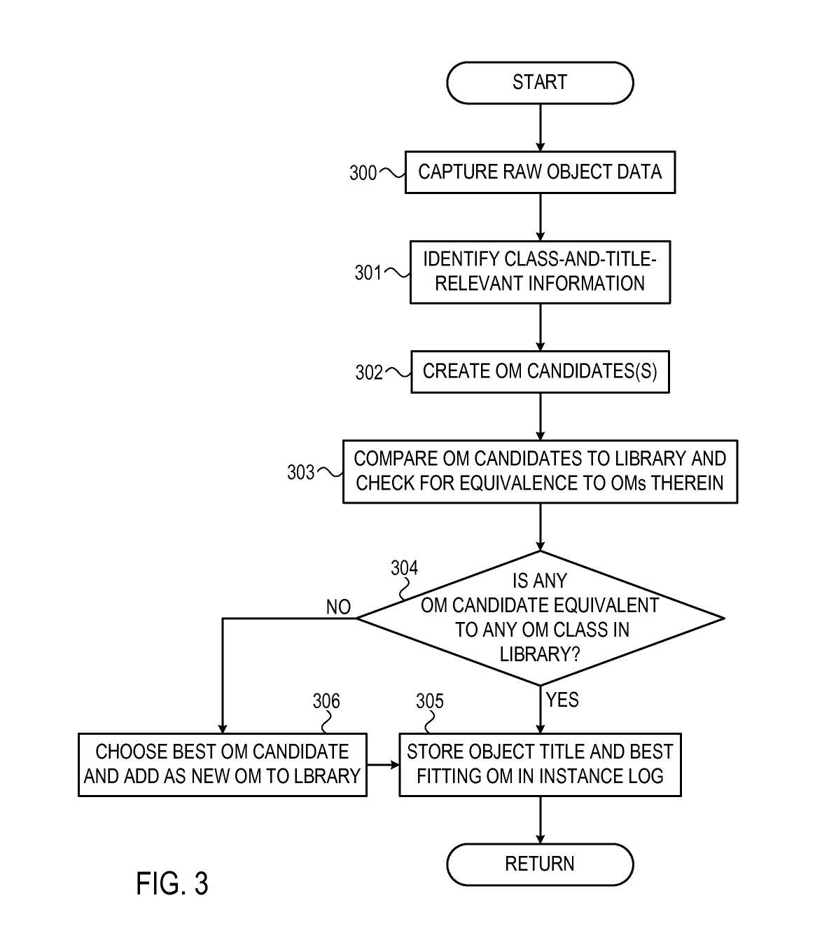

Example (FIG. 1): The following example is a preferred embodiment of the present invention. A system comprising a number of computers (PCs) running on the MS Windows operating system and connected to the Internet, each provided with listener software; a dedicated remote computer, running on Microsoft Server operating system and connected to the Internet; an RSA based cryptographic software on PCs and server providing a secure channel of communications over the Internet. The server is provided with a memory device storing an updatable library of object models (SMs) and a log of OM Instances.

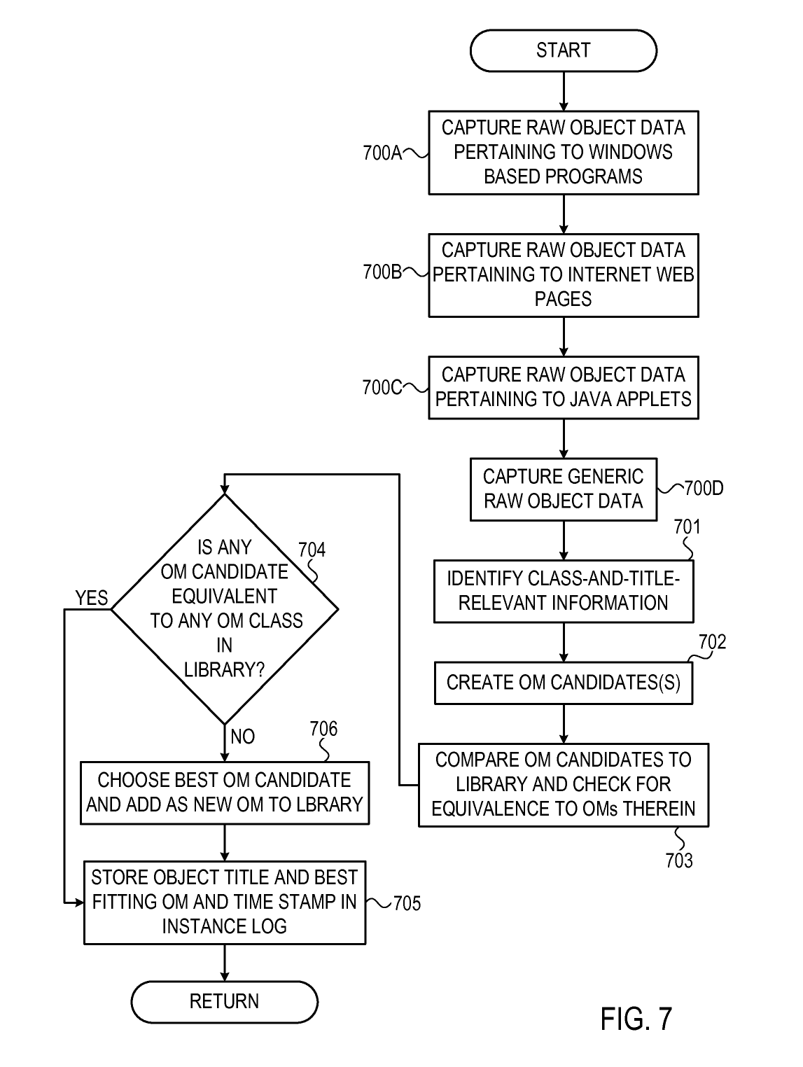

An exemplary method disclosed and enabled by the present invention is as follows (FIG. 7): The listener software on each PC retrieves data on usage of Windows based programs using Windows system calls, DLL injection and system events (capture raw object data pertaining to Windows based programs) (700a); additionally, the listener uses a Browser Helper Object (BHO) plugin to access Document Object Model (DOM) of web pages in use (capture raw object data pertaining to Internet web pages) (700b); data on Java applets is captured using the Java software platform (capture raw object data pertaining to Java applets) (700c); further the Microsoft User Interface Automation is used to collect information about user interface elements (capture generic raw object data) (700d). The listener program on each PC transmits said captured data to server via the secure channel. On the server, a program analyzes the captured raw data for information pertaining to the class and value of objects (identify class- and title-relevant information, 701), and creates for each object a candidate object model (SM) (create OM candidates, 702). The program then further compares the candidate OMs with OMs in said library (compare OM candidates to library and check for equivalence to OMs therein, 703), and stores object title, best fitting OM and time stamp in instance log (705). For objects lacking any matching OMs, the candidate OM is promoted to OM status by adding it to the library (706), and the match to new OM is recorded in log together with time stamp (705). The program periodically, and also upon request, produces a statistical summary of log.

What is claimed is:

1. A system for automatically interpreting object usage on a plurality of end users' computers comprising:
a. a plurality of computers used by end users (EUCs);
b. a central server with processing means and first information storage means adapted for storing:
i. captured raw object (SO) data;
ii. an updatable library of object classes;
iii. computer readable instructions for identifying class-relevant and title-relevant information in raw object data and comparing to said library of object classes, or object models (SMs);
iv. a log of OM instances, comprising data on class, title, time and duration of usage of said OM instances; and,
c. a plurality of listener devices possessing a second information storage means and first means of communications with one or more EUCs, and adapted for obtaining from said EUCs information on object activity, and a second means of communication with server for passing said object usage information,
wherein said server processing means comprises an identifying means for object class-relevant and title-relevant information in raw object data, instructions for creating OM candidates and comparing to said candidates to updatable library of OMs and determining either the assignation of an existing class to OM instance according to predetermined criteria or conferring permanent class status to OM candidate by adding it to said updatable library of classes, server further recording assigned class, as well as title and object usage information in said object instance log.

2. The system of claim 1, wherein said object is selected from a group consisting of screen types, Button Control Type, Calendar Control Type, CheckBox Control Type, ComboBox Control Type, DataGrid Control Type, Data Item Control Type, Document Control Type, Edit Control Type, Group Control Type, Header Control Type, HeaderItem Control Type, Hyperlink Control Type, Image Control Type, List Control Type, ListItem Control Type, Menu Control Type, MenuBar Control Type, Menu Item Control Type, Pane Control Type, ProgressBar Control Type, RadioButton Control Type, ScrollBar Control Type, Separator Control Type, Slider Control Type, Spinner Control Type, SplitButton Control Type, StatusBar Control Type, Tab Control Type, TabItem Control Type, Table Control Type, Text Control Type, Thumb Control Type, TitleBar Control Type, ToolBar Control Type, ToolTip Control Type, Tree Control Type, TreeItem Control Type, Window Control Type or any combination thereof.

3. The system of claim 1, wherein the OM library is structured hierarchically, with said object classes grouped into class levels, and further wherein the stored computer readable instructions further comprise instructions for creating OM of each raw datum at a plurality of levels, and for identifying and storing OM instances at a plurality of levels.

4. The system of claim 1 with a user feedback module comprising a user interface displaying to human user results of automatic OM identification produced by the server and receiving corrections from said user, wherein said corrections are fed back to the server to improve library of previously stored Object Models and possibly also to change stored instructions for class and title identification and matching with OM library.

5. The system of claim 1, wherein said server further comprises a database of organizational structure, including departmental affiliation and professional roles of owners of individual EUCs and stored instructions for extracting a plurality of OM usage statistics comprising OM usage time averages per individual user, per department, per role.

6. The system of claim 1, wherein listener module further comprises means for recording error information provided by EUC for errors encountered while attempting to run and errors captured during successful runs of individual OMs, and wherein server also has instructions for extracting OM error statistics.

7. The system of claim 1 wherein said system of interpreting object usage is implemented on a Microsoft Windows platform, and further wherein said listener is adapted to retrieve data on user's object usage from windows system-call, dll-injection and system events.

8. The system of claim 1, wherein listener is adapted to retrieve data on user's object usage of objects consisting of web-based documents is retrieved via Browser Helper Object (BHO) module.

9. The system of claim 1, wherein data on user's object usage of Java-based programs is identified using inner java-mechanics.

10. The system of claim 1, wherein data on user's object usage is based on User-Interface-Automation technique.

11. The system of claim 1, wherein discovery of OMs is achieved via “class”-dependent heuristics

12. The system of claim 1, wherein discovery of OMs is achieved via heuristics based on statistics for overall matching percentages (for example, percentage of data left unmatched, number of models percentage of data each model matches)

13. The system of claim 1 further comprising a cloud server enabling EUC to store data and perform computations on cloud server, wherein listener module further comprises a means for capturing data and instructions transmitted between computer and cloud server, useful for identifying objects running on cloud (18).

14. The system of claim 1 wherein at least one of the following is held true:
a. first and second identifying means are adapted for using the document object model (DOM) structure of objects consisting of HTML, XHTML or XML documents to identify object class and title relevant information; and
b. DOM model is specified by the World Wide Web Consortium (W3C) DOM standard.

15. A method for using a system for automatically interpreting object usage on end user computers, the system comprising a plurality of end user computers (EUCs), a plurality of listening devices (listeners) and a central server (server), and at least one database stored in the memory of the server having a processing means and information storage means adapted for storing captured raw object (SO) data, an updatable library of object classes, computer readable instructions for identifying class-relevant and title-relevant information in raw object data and comparing to said library of object classes, or object models (SMs), a log of OM instances, comprising data on class, title, time and duration of usage of said OM instances, the method comprising steps of:
a. receiving raw object (SO) data from EUCs to be stored in said listeners and server memory;
b. identifying within said raw object, object class and object title relevant information and automatically creating at least one Object Model (SM) candidate class;
c. comparing said at least one OM candidate class to OMs in said updatable OM library and determining whether said at least one candidate class is equivalent to one class in OM library;
d. if said at least one OM candidate class is equivalent to an OM in said library, storing said OM from library and title and temporal usage information as OM instance in OM instance log; and
e. if none of said at least one OM candidate class is equivalent to any OM in library, choosing one of OM candidates and adding to said library, thereby creating new OM, storing said OM and title and temporal usage information as OM instance in OM instance log.

16. The method according to claim 15 wherein said object is selected from a group consisting of screen type, Button Control Type, Calendar Control Type, CheckBox Control Type, ComboBox Control Type, DataGrid Control Type, Data Item Control Type, Document Control Type, Edit Control Type, Group Control Type, Header Control Type, HeaderItem Control Type, Hyperlink Control Type, Image Control Type, List Control Type, ListItem Control Type, Menu Control Type, MenuBar Control Type, Menu Item Control Type, Pane Control Type, ProgressBar Control Type, RadioButton Control Type, ScrollBar Control Type, Separator Control Type, Slider Control Type, Spinner Control Type, SplitButton Control Type, StatusBar Control Type, Tab Control Type, TabItem Control Type, Table Control Type, Text Control Type, Thumb Control Type, TitleBar Control Type, ToolBar Control Type, ToolTip Control Type, Tree Control Type, TreeItem Control Type, Window Control Type or any combination thereof.

17. The method of claim 15 wherein at least one of the following is held true:
a. further providing a cloud server enabling EUC to store data and perform computations on cloud server, wherein listener module further capturing data and instructions transmitted between computer and cloud server, useful for identifying objects running on cloud;
b. listeners and sever is provided with encryption means useful for secure communications, and wherein all communication between them is performed over said secure channel;
c. a listener is provided on each EUC by downloading from global communications network a computer program (installer) adapted for installing said listener on said EUC;
d. discovery of OMs is achieved via heuristics based on statistics for overall matching percentages (for example, percentage of data left unmatched, number of models, percentage of data each model matches);
e. discovery of OMs is achieved via “class”-dependent heuristics;
f. data on user's object usage is identified based on User-Interface-Automation technique;
g. data on user's object usage of Java-based programs is identified using inner java-mechanics;
h. retrieving data on user's usage of objects consisting of web-based documents is retrieved by said listener via a Browser Helper Object (BHO) module;
i. useful for interpreting object usage on a Microsoft Windows platform, wherein said listener is used for retrieving data on the user's object usage from windows system-call, dll-injection and system events.
j. the listener captures and transmits to server information further comprising error information provided by EUC for errors encountered while attempting to run and errors captured during successful runs of individual OMs, and further wherein server also extracts OM error statistics;
k. further providing in information stored on server a database of organizational structure, including departmental affiliation and professional roles of owners of individual EUCs (users), wherein said information is used for extracting a plurality of OM usage statistics comprising OM usage time averages per individual user, per department, per role;
l. providing the system with a user interface on EUC and instructions in memory of server for obtaining user feedback, and further displaying to human user results of automatic OM identification produced by server and receiving corrections from said user, wherein said corrections are fed back to the server to improve library of previously stored OMs and possibly also to change stored instructions for class and title identification and matching with OM library;
m. said identification of object class and title relevant information is performed at a multiplicity of class levels and further wherein said object class candidates are created for each class level and further wherein comparison with library OMs is performed for each level, and identified class instances are logged for each class level;

18. The method of claim 15 wherein identifying class and title information of objects consisting of HTML, XHTML or XML documents of type is achieved using the document object model (DOM) structure.

19. The method of claim 18 wherein DOM model is specified by the World Wide Web Consortium (W3C) DOM standard.

20. A method for extracting software usage and error statistics, comprising:
a. providing a means for monitoring and automatically identifying object (SO);
usage by EUC users, and further monitoring error messages related to said objects;
b. further providing a database of organizational structure, including departmental affiliation and professional roles of owners of individual EUCs (users); and
c. combining said identified object usage and error data into usage statistics, comprising:
i. length of time it takes to open client documents and programs;
ii. number of errors during each process;
iii. rates at which various document types and programs are aborted;
iv. attribution of abort to triggering by another process; and
v. partial statistics by department and roll.
